(19) United States
(12) Patent Application Publication
(10) Pub. No.: US 2004/0234744 A1
(43) Pub. Date: Nov. 25, 2004

(54) Vehicle interior trim component of basalt fibers and thermoplastic binder and method of manufacturing the same

(76) Inventors: George B. Byma, Clarkston, MI (US); Brian A. Cristea, Royal Oak, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 10/440,708

(22) Filed: May 19, 2003

(51) Int. Cl. B32B 5/24; B32B 5/18; B32B 17/02

(52) U.S. Cl. 428/304.4; 428/317.9; 442/22; 442/27; 442/55; 156/166

(57) ABSTRACT

A laminate for use as a headliner comprises a core having an inner layer of thermoplastic binder adjacent opposing sides thereof. A basalt structural reinforcement layer is provided adjacent each inner layer of thermoplastic binder. An outer layer of thermoplastic binder is applied adjacent each reinforcement layer. A scrim layer is applied adjacent one outer layer of thermoplastic binder and an adhesive layer and covering are provided adjacent the other outer layer of thermoplastic binder. A method of manufacturing the laminate comprises the steps of providing a scrim layer and a layer of thermoplastic binder. A basalt structural reinforcement layer is provided adjacent the layer of thermoplastic binder. Another layer of thermoplastic binder is provided adjacent the basalt structural reinforcement layer. A core is provided adjacent the layer of thermoplastic binder. Another basalt structural reinforcement layer is provided adjacent the core. Finally, a final binder layer is provided adjacent the basalt structural reinforcement layer to complete a composite structure. The invention is further directed toward a method for recycling laminate material. The method comprises the steps of providing a laminate material formed of composite materials including reinforcement fibers that have a higher melting point than the incineration point of the other composite materials and heating the laminate to a temperature below the melting point of the basalt and above the incineration point of the other composite materials to reduce the other composite materials to ash without melting the basalt.

### BACKGROUND OF INVENTION

The present invention pertains generally to molding of composite materials, including fibers and plastics and, more particularly, to molding of structural and acoustical panels, which include basalt fibers and a thermoplastic binder.

Composite material panels are used in many different applications, including automobiles, airplanes, trains, and housing and building construction. The properties sought in such panels are strength, rigidity, sound absorption, and heat and moisture resistance. One application of such panels that has been especially challenging is with automobile headliners and other automotive interior panels. Many different types of laminates and laminated composites have been tested and produced for use in automobiles.

Some headliners have a core of glass fibers and a polyester resin. Others have a core of open cell polyurethane foam impregnated with a thermosetting resin and a reinforcing layer of fiberglass. Still others have a first fiber-reinforcing mat, such as a glass fiber mat, on one side of a fibrous core and a second fiber-reinforcing mat on the opposite side to form a laminate. The exposed surfaces of the reinforcing mats are then coated with a resin and an outer covering is applied. The composite or laminate is ultimately formed to a desired shape under heat and pressure (i.e., compression molding) and cut to a desired size by a trimmer.

Although manufacturers strive to minimize the amount of material that is removed from the headliner when trimmed, material is still removed. It is desirable, and sometimes required, that the material removed be recycled as well as end of life for the part. One method of recycling that is gaining popularity involves incineration and reclamation of the energy resulting from the incineration.

Regardless of the method of construction, headliners containing glass fibers shorten the life of the furnace used for recycling. This occurs because the furnace must be heated to a temperature that exceeds the melting point of the glass in order to reduce the other composite materials to ash. The melted glass coats the furnace and solidifies when cooled. The solid glass is difficult to remove from the walls of the incinerator. What is needed is a headliner composition that meets its functional requirements while, at the same time, is more suitable for recycling.

### SUMMARY OF INVENTION

The present invention is directed toward a headliner that meets the foregoing needs. More particularly, the invention is directed toward a laminate for use as a headliner. The laminate comprises a core having an inner layer of thermoplastic binder adjacent opposing sides thereof. A basalt structural reinforcement layer is provided adjacent each inner layer of thermoplastic binder. An outer layer of thermoplastic binder is provided adjacent each reinforcement layer. A scrim layer is provided adjacent one outer layer of thermoplastic binder and an adhesive layer and covering are provided adjacent the other outer layer of thermoplastic binder.

A method of manufacturing the laminate comprises the steps of providing a scrim layer and a corresponding layer of thermoplastic binder. A basalt structural reinforcement layer is provided adjacent the layer of thermoplastic binder. Another layer of thermoplastic binder is provided adjacent the basalt structural reinforcement layer. A core is provided adjacent the layer of thermoplastic binder. Another layer of thermoplastic binder is provided adjacent an exposed side of the core 12. Another basalt structural reinforcement layer is provided adjacent this layer of thermoplastic binder. Finally, a final thermoplastic binder layer is provided adjacent the basalt structural reinforcement layer to complete a composite structure. A covering may be applied to the composite structure.

The invention is further directed toward a method for recycling laminate material. The method comprises the steps of providing a laminate material formed of composite materials including reinforcement fibers that have a higher melting point than the incineration point of the other composite materials to reduce the other composite materials to ash without melting the reinforcement fibers.

Various objects and advantages of this invention will become apparent to those skilled in the art from the following detailed description of the preferred embodiment, when read in light of the accompanying drawings.

### BRIEF DESCRIPTION OF DRAWINGS

FIG. 1 is a schematic representation of the laminated structure according to a composite preferred embodiment of the invention;

FIG. 2 is a schematic representation of a manufacturing set-up for producing a composite substrate in accordance with a method of manufacture according to a preferred embodiment of the invention; and

FIG. 3 is a schematic representation of a manufacturing set-up for producing the composite laminated structure shown in FIG. 1 in accordance with a method of manufacture according to a preferred embodiment of the invention.

### DETAILED DESCRIPTION

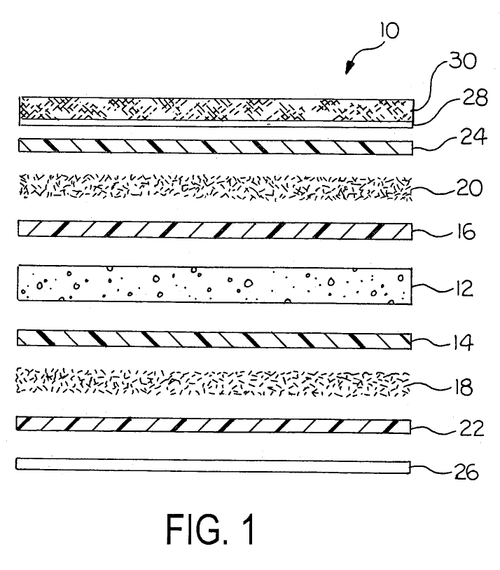

Now with reference to the drawings, wherein like numerals designate like components throughout all of the several figures, there is schematically represented in FIG. 1 a laminate, collectively referenced at 10, according to a preferred embodiment of the invention, for use as a headliner, or other interior component, of an automobile. The laminate 10 is made up of combined materials including a core 12. A layer of thermoplastic binder 14, 16 is applied to opposing sides of the core 12 (i.e., above and below the core 12 when viewing FIG. 1). Structural reinforcement layers 18, 20 are provided on each side of the core 12, adjacent the layers of thermoplastic binder 14, 16. Another layer of thermoplastic binder 22, 24 is applied to opposing sides of the core 12 adjacent the reinforcement layers 18, 20. A scrim 26 is applied to one side of the core 12 (i.e., at the bottom of the laminate 10 when viewing FIG. 1) next to a corresponding layer of binder 22 and a reinforcement layer 18. An adhesive layer 28 and a covering 30 are provided adjacent the other side of the core 12 (i.e., atop the laminate 10 when viewing FIG. 1) next to a corresponding layer of binder 24 and a reinforcement layer 20. Alternatively, the adhesive layer 28 and the covering 30 may be pre-laminated together to be a single composite layer.

The core 12 is most preferably made of polyurethane resin (PUR) foam due to its light weight, compression resistance, moldability, acoustic absorption, and ability to allow engineered solutions to automotive overhead systems problems. The core 12 may vary in thickness and density and internal load deflection (ILD). For example, the core 12 may have a thickness in a range from about 2 mm to about 30 mm and a density in a range from about 1.0 lb/ft³ to about 3.5 lb/ft³. The composition, thickness, and density of the core 12 depend upon depth of draw (i.e., the vertical dimension that the laminate departs from a flat horizontal plane), acoustical requirements, and load bearing requirements. It should be understood that the aforementioned core compositions and thickness and density ranges are given as examples and that the invention is not limited to such compositions or ranges.

The layers of thermoplastic binder 14, 16 and 22, 24 are preferably in the form of polyethylene (PE) adhesive films. Alternatively, the layers of binder 14, 16 and 22, 24 may be, for example, polypropylene or nylon film. Alternatively, the binder 14, 16 and 22, 24 may be a powder of the same polymers or a blend of the these. The weight of the binder 14, 16 and 22, 24 may be in a range from about 20 g/m² to about 200 g/m² and is most preferably matched to the gram weight of the fibers that it is intended to bind. These weights can be adjusted to increase or decrease stiffness properties or load bearing capabilities of the resulting headliner. It should be appreciated that the binder 14, 16 and 22, 24 does not saturate or appreciably impregnate the core 12, except for possibly minimal surface saturation. The binder 14, 16 and 22, 24, when heated, softens to allow the laminate 10 to be molded or shaped as desired and an ultimate sequential bonding occurs as the laminate 10 cools and the binder 14, 16 and 22, 24 cools and hardens. It should be understood that the aforementioned binder 14, 16 and 22, 24 weights are given as examples and that the invention is not limited to such weights.

The structural reinforcement layers 18, 20 are preferably fibers and most particularly basalt fibers. The fibers may be continuous or chopped and may be coated with a sizing treatment, which makes the fibers highly compatible with the thermoplastic binder. The fibers may be allowed to fall randomly to opposing sides of the core 12, adjacent corresponding adhesive layers 14, 16. The structural reinforcement layers 18, 20 preferably have a weight in a range from about 20 g/m2 to about 200 g/m² to create a composite of appropriate strength and stiffness to support the OEM requirement, although other weights may be suitable for carrying out the invention. The basalt fibers have a high tensile strength. The tensile strength of basalt fibers compared to E-glass fibers shows the basalt to be superior (i.e., about 4840 Mpa for basalt versus about 3450 Mpa for E-glass). The melting point of basalt is higher than E-glass. This makes basalt superior to glass in terms of recycling and energy reclamation and tensile strength, as will become more apparent in the description that follows. It should be appreciated by one of ordinary skill in the art of the invention that the structural reinforcement layers 18, 20 can be in the form of a prefabricated mat formed from basalt fibers and a binder for holding the fibers together.

The scrim layer 26 is preferably made of a lightweight polymer or plastic film, such as polyethylene terephthalate (PET), nylon, or blends thereof. The melting point of the scrim layer 26 is preferably higher than the forming die temperature so that the scrim layer 26 does not stick to the die. The scrim layer 26 may function to retain the resin within the laminate 10 and thereby prevent the thermoplastic binder from reaching the forming die of a mold, as will become apparent in the description that follows. Hence, the scrim layer 26 may aid in releasing the laminate 10 from the forming die. This works for plastic scrims as long as the melting point is above the forming die temperature, as stated above. The scrim layer 26 may also be used to bond with and add strength or provide additional rigidity to the adjacent reinforcement layer 18, assist in holding the adjacent reinforcement layer 18 together, and/or have shape-retention properties. Furthermore, the scrim layer 26 preferably provides a finished surface for mounting against the roof of an automobile and prevents or reduces vibration or abrasion noise when in contact with the roof.

The binders 22, 24 preferably have a great affinity for the scrim layer 26, the covering 30, and the basalt fiber layers 20 so that the layers above and below the layers of binder 22, 24 readily adhere to the binder 22, 24. The binder is controlled by process temperatures. The binder may bleed into the scrim layer and cause a mechanical bond. Accordingly, the cover layers (i.e., the scrim layer 26 and covering 30) may be weighty enough to absorb the binder or the binders are used in quantities that would prevent this penetration.

The adhesive layer 28 and the covering 30 are applied over a corresponding layer of binder 24 to complete the laminate 10. The purpose of the adhesive layer 28 is to adhere the cover material layer to the binder and basalt fiber reinforcing layer. The covering 30 is preferably made of headliner fabric or cloth, which may be a woven or non-woven textile with a polymer base, such as nylon or polyester. Alternatively, the covering 30 may be made of vinyl, leather, or the like. The covering 30 may be decorative to provide an aesthetically pleasing finished surface and preferably has a flexible character with sufficient stretch characteristics to allow the material to match the design shape of the headliner. If a soft feel to the covering 30 is desired, the covering 30 may include a substrate in the form of foam (not shown), as is commonly known to one skilled in the art. The foam may also function as an acoustical absorption material. In such event, the adhesive layer 28, the foam, and the covering 30 can be pre-laminated together to be a single composite layer.

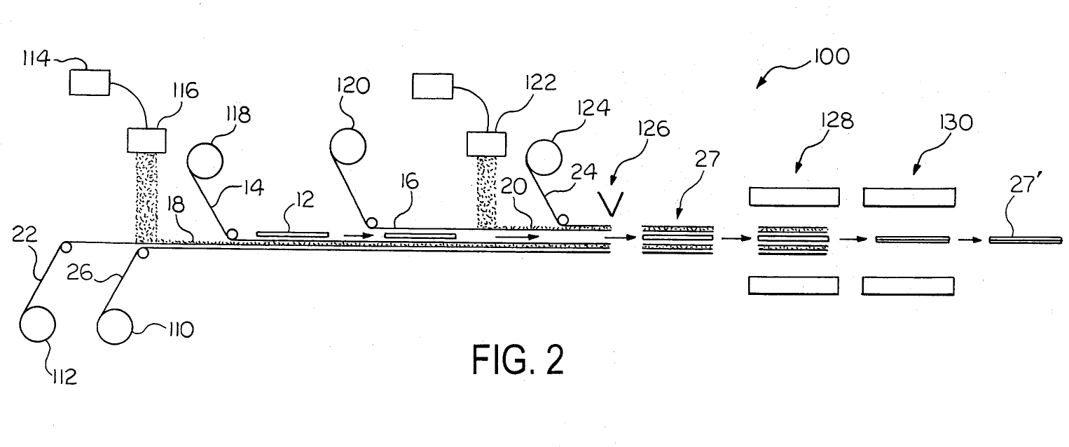

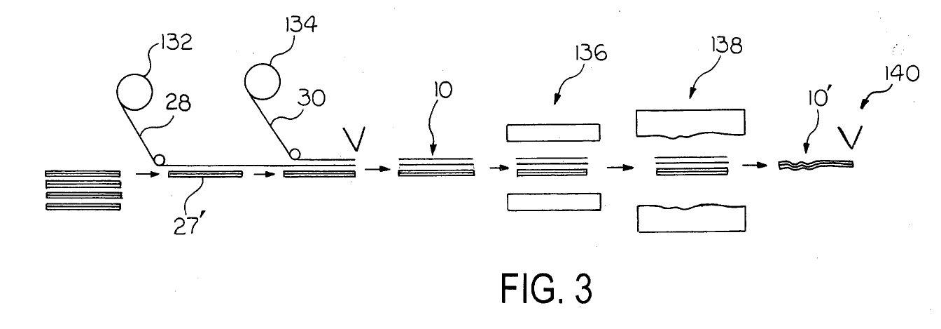

A method of manufacturing the laminate 10 is described with reference to FIGS. 2 and 3. In an assembly line set-up indicated generally at 100, the scrim layer 26 and a corresponding layer of thermoplastic binder 22 (i.e., a binder film) are pulled from spools 110, 112 and fed under a fiber cutting or distribution source for random distribution of fibers. The fibers are preferably mineral fiber strands or rovings and, most particularly, basalt fiber strands or rovings to form a structural reinforcement layer 18. The fiber strands or rovings may be supplied from a reservoir 114 and randomly applied to the binder layer 22, preferably in a random gravity-fed fashion, such as by sprinkling fibers thereof from an agitator tray or chopper 116 positioned over the binder layer 22 (i.e., atop the binder film layer 22 when viewing FIG. 2). It should be appreciated that the fibers may be applied by manual distribution from a container or cut from continuous strands or rovings directly above the binder and scrim layers 22 and 26 and allowed to fall randomly upon the binder layer 22. It should further be appreciated that the structural reinforcement layer 18 may be in the form of a prefabricated basalt fiber mat, as described above, that can be pulled from a spool (not shown), thus eliminating the need for the reservoir 114 and the chopper 116.

Another layer of thermoplastic binder 14 (i.e., another binder film) is pulled from a spool 118 and fed over the structural reinforcement layer 18. The core 12 is fed from a stack of blanks onto this binder layer 14. The core 12 can be fed manually or automatically through the aid of machinery.

Another layer of thermoplastic binder 16 (i.e., another binder film) is pulled from a spool 120 over the core 12. Thereafter, the core 12 is passed under another chopper 122, which chops more basalt fibers, and randomly deposits those chopped fibers, on the exposed binder layer 16 to form another structural reinforcement layer 20. The fibers are oriented to the plane of the core 12 at an infinite number of angles.

It should be appreciated that this structural reinforcement layer 20, like the structural reinforcement layer 18 described above, may be in the form of a prefabricated basalt fiber mat that can be pulled from a spool (not shown).

The final binder layer 24 (i.e., binder film) is guided from a spool 124 onto the exposed structural reinforcement layer 20 to complete a composite structure 27. The composite structure 27 is cut to a desired length by a cutter 126 and then passes though contact heat and cooling to form a laminated composite substrate 27′.

In the same or a subsequent operation, as depicted in FIG. 3, the final adhesive layer 28 and the covering 30 are guided from spools 132, 134 onto the exposed binder layer 24 to complete the laminate 10. As stated above, the adhesive layer 28 and the covering 30 may be pre-laminated together to be a single composite layer. In such case, the composite layer may be pulled from a single spool, thus eliminating the need for one of the two spools 132, 134.

The laminate 10 is then exposed to radiant or contact heat, as indicated at the heating device 136, and conveyed to a mold 138 (e.g., a mold that removes heat from the laminate). As is known in the art, the heating device 136 is at temperature sufficient to melt the adhesive layers 14, 16, 22, 24, and 28. It should be appreciated that the adhesive layer 28 and the covering 30 may be pre-laminated as a cover material composite. The composite structure may be heated and then bonded to the cold pre-laminated adhesive layer 28 and cover 30 or the pre-laminated adhesive layer 28 and cover 30 may be brought into the press preheated separately from the composite structure. Pressure is applied by the mold 138 to compress the laminate 10 to conform to the internal configuration of the mold 138. The molded laminate 10′ may then be cut as desired, for example, to form a completed headliner, by final trimmer 140, which is well known in the art.

A principle advantage of the invention is with regard to recycling material removed from the laminate 10 by the final trimmer 140. Since the laminate 10 according to the present invention includes mineral fibers (e.g., basalt fibers) that have higher melting point than the incineration point of the other composite materials, the laminate 10 and trimmings therefrom may be incinerated and energy resulting therefrom may be reclaimed, thus achieving desired or required recycling efforts. The composite materials of the laminate 10, but for the mineral fibers, are reduced to ash.

The mineral fibers do not melt if the temperature of the incinerator is controlled and thus do not coat the incinerator. The ash and basalt fibers can easily be removed from the incinerator. Since the incinerator is not covered with molten fibers, as is the case with glass fibers, the life of the incinerator is prolonged.

Hence, the invention further includes a method of recycling laminate materials including one or more fiber layers, wherein the fibers are basalt fibers having a higher melting point than the incineration point of the other composite materials.

An additional advantage of the basalt fibers is that the fibers have an appreciably higher tensile strength than conventional E-glass fibers. Basalt fibers are reported to have a tensile strength of 4840 Mpa, while E-glass fibers have a tensile strength of 3450 Mpa. The increase in tensile strength of the fibers has the potential to allow a decrease in the quantity of the fibers that are required and may thereby offer a weight reduction in the laminate 10. This lower weight also has the possibility of offering a more cost competitive product if the reduced weight can positively offset the cost of the basalt fibers.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A laminate for use as a headliner for an automobile, the laminate comprising:
a core having opposing sides;
an inner layer of thermoplastic binder applied to said opposing sides of said core;
a structural reinforcement layer provided on each said inner layer of thermoplastic binder, said structural reinforcement layers being basalt fibers;
an outer layer of thermoplastic binder applied adjacent each said reinforcement layer;
a scrim layer applied to one said outer layer of thermoplastic binder; and
an adhesive layer and a covering provided adjacent the other said outer layer of thermoplastic binder.

2. The laminate of claim 1, wherein said core is made of polyurethane resin foam.

3. The laminate of claim 1, wherein said layers of thermoplastic binder are in the form of polyethylene adhesive films.

4. The laminate of claim 1, wherein said layers of thermoplastic binder are in the form of polyethylene powder.

5. The laminate of claim 1, wherein said layers of thermoplastic binder do not impregnate said core.

6. A method of manufacturing a laminate, comprising the steps of:
a) providing a scrim layer and a corresponding layer of thermoplastic binder;
b) applying a basalt structural reinforcement layer to the layer of thermoplastic binder;
c) applying another layer of thermoplastic binder to the basalt structural reinforcement layer;
d) applying a core to the layer of thermoplastic binder applied in step c);
e) applying another layer of thermoplastic binder to the core;
f) applying another basalt structural reinforcement layer to the layer of thermoplastic binder applied in step e); and
g) applying a final binder layer to the basalt structural reinforcement layer applied in step f) to complete a composite structure.

7. The laminate of claim 6, wherein said core is made of polyurethane resin foam.

8. The laminate of claim 6, wherein said layers of thermoplastic binder are in the form of polyethylene adhesive films.

9. The laminate of claim 6, wherein said layers of thermoplastic binder are in the form of polyethylene powder.

10. The laminate of claim 6, wherein said layers of thermoplastic binder do not impregnate said core.

11. The laminate of claim 6, wherein proceeding step g), the composite structure is cut and then passed though contact heat and cooling to form a laminated composite substrate.

12. The laminate of claim 11, further comprising the steps of:
g) applying a final adhesive layer and a covering to the laminated composite substrate to complete the laminate;
h) exposing the laminate to heat; and
i) molding in a mold that removes the heat from the laminate.

13. The laminate of claim 11, cutting the laminate as desired.

14. A method for recycling laminate material, comprising the steps of:
a) providing a laminate material formed of composite materials including reinforcement fibers that have a higher melting point than the other composite materials; and
b) heating the laminate to a temperature below the melting point of the basalt and above the melting point of the other composite materials to reduce the other composite materials to ash.

15. The method of claim 14, wherein energy resulting from step b) is reclaimed to achieve a recycling effort.

16. The method of claim 14, wherein step b) further comprised the steps of placing the laminate in an incinerator prior to heating the laminate and then removing the ash and basalt fibers from the incinerator after heating the laminate.

17. The method of claim 14, wherein reinforcement fibers are entirely basalt.
